(19) United States
(12) Patent Application Publication
(10) Pub. No.: US 2011/0145117 A1
(43) Pub. Date: Jun. 16, 2011

(54) Clearing System That Determines Settlement Prices of Derivatives in Financial Portfolios

(75) Inventors: Kevin Fallon, Salem, WI (US); Ketan Patel, Hanover Park, IL (US); Moody Hadi, New York, NY (US); Michal Koblas, Praha (CZ); Dipanker Bose, Essex (GB); Simon Evans, London (GB)

(73) Assignee: CHICAGO MERCANTILE EXCHANGE INC., Chicago, IL (US)

(21) Appl. No.: 12/638,810

(22) Filed: Dec. 15, 2009

(51) Int. Cl. G06Q 40/00; G06Q 10/00

(52) U.S. Cl. 705/35; 705/400

(57) ABSTRACT

Methods, systems and apparatuses are described for credit default swap (CDS) settlement pricing. The method includes receiving at least quoted prices and/or executed prices, and using them to calculate a settlement price of CDSs in a portfolio. The calculation of the settlement price may also consider other information, such as recovery rate, hazard rate function, etc. The invention also may include an electronic trading platform that is fully integrated with a central counterparty clearing facility for CDSs.

### TECHNICAL FIELD

The present invention relates to a portfolio of financial instruments. In particular, aspects of the invention relate to calculating the settlement price of financial derivatives in a portfolio.

### BACKGROUND

According to Wikipedia, a credit default swap (CDS) is a swap contract in which the buyer of the CDS makes a series of payments to the seller and, in exchange, receives a payoff if a credit instrument (typically a bond or loan) goes into default (fails to pay). Less commonly, the credit event that triggers the payoff can be a company undergoing restructuring, bankruptcy, or even just having its credit rating downgraded.

There are two competing theories usually advanced for the pricing of credit default swaps, Wikipedia explains. The first, referred to as the ‘probability model’, takes the present value of a series of cash flows weighted by their probability of non-default. This method suggests that credit default swaps should trade at a considerably lower spread than corporate bonds. The second model, proposed by Darrell Duffle, but also by John Hull and White, uses a no-arbitrage approach.

Techniques for valuing credit default swaps and determining their settlement price are known in the industry. However, enhanced techniques and apparatuses to better calculate settlement prices and value a portfolio of credit default swaps is desired.

### BRIEF SUMMARY

Methods, systems and apparatuses are disclosed for credit default swap settlement pricing using a settlement pricing module. The method includes receiving at least quoted prices and/or executed prices, and using them to calculate settlement prices of CDSs in a portfolio. The calculation of the settlement price may also consider other information, such as recovery rate, hazard rate function, etc.

Moreover, various aspects of the aforementioned methodology may be implemented in an apparatus comprising a settlement pricing module, one or more processors (e.g., settlement pricing processor), one or more memories, and other modules. Information may be stored in the memories to assist the settlement pricing module (or settlement pricing processor) in calculating the price data of a portfolio of credit derivatives.

Of course, the methods and systems of the above-referenced embodiments may also include other additional elements, steps, computer-executable instructions, or computer-readable data structures. In this regard, other embodiments are disclosed and claimed herein as well. In other embodiments, the present invention can be partially or wholly implemented on a computer-readable medium, for example, by storing computer-executable instructions or modules, or by utilizing computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF DRAWINGS

The present invention may take physical form in certain parts and steps, embodiments of which will be described in detail in the following description and illustrated in the accompanying drawings that form a part hereof, wherein:

FIG. 1 depicts an illustrative computer network system that may be used to implement various aspects of the invention;

FIG. 2 illustrates an exemplary methodology in accordance with aspects of the invention; and

FIG. 3 shows a flowchart of various aspects of an exemplary settlement pricing module (or settlement pricing processor) in accordance with various aspects of the invention.

### DETAILED DESCRIPTION

The invention relates to a methodology and algorithm for credit default swap (CDS) settlement pricing that accounts for buy side information, sell side information and/or trade input factors. The system and method for determining CDS settlement pricing provides a transparent and easy to replicate means for accurately determining the price and value of an open CDS. The invention includes an electronic trading platform that is fully integrated with a central counterparty clearing facility for CDS.

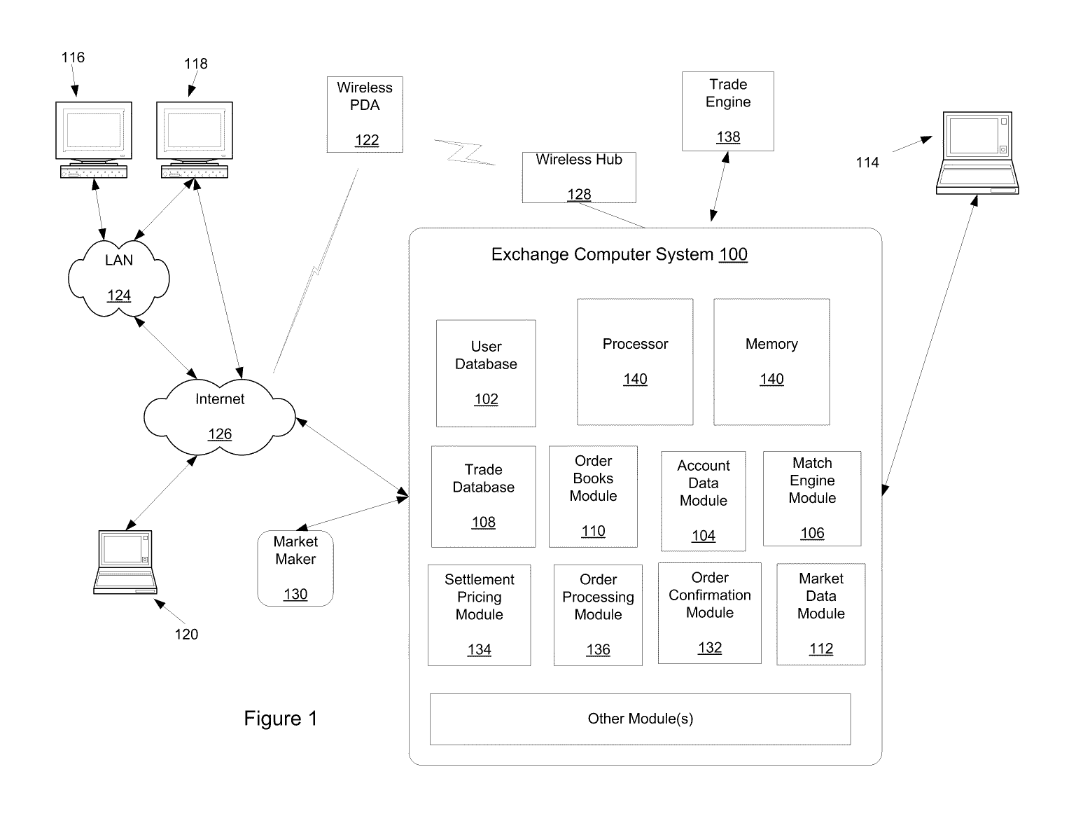

FIG. 1 depicts an illustrative operating environment that may be used to implement various aspects of the invention. The operating environment is only one example of a suitable operating environment and is not intended to suggest any limitation as to the scope of use or functionality of the invention. Aspects of the invention are preferably implemented with computer devices and computer networks that allow the exchange/transmission/reception of information including, but not limited to settlement prices and trading information. An exchange computer system 100 receives market data, analyzes historical data, and may calculate various values, e.g., settlement prices, performance bond amounts, etc., in accordance with aspects of the invention.

Exchange computer system 100 may be implemented with one or more mainframes, servers, gateways, controllers, desktops or other computers. The exchange computer system 100 may include one or more modules, processors, databases, and other components, such as those illustrated in FIG. 1. Moreover, computer system 100 may include one or more processors 140 (e.g., Intel® microprocessor, AMD® microprocessor, settlement pricing processor, etc.) and one or more memories 142 (e.g., solid state, DRAM, SRAM, ROM, Flash, non-volatile memory, hard drive, registers, buffers, etc.) In addition, an electronic trading system 138, such as the Globex® trading system, may be associated with an exchange 100. In such an embodiment, the electronic trading system includes a combination of globally distributed computers, controllers, servers, networks, gateways, routers, databases, memory, and other electronic data processing and routing devices. The trading system may include a trading system interface having devices configured to route incoming messages to an appropriate devices associated with the trading system. The trading system interface may include computers, controllers, networks, gateways, routers and other electronic data processing and routing devices. Orders that are placed with or submitted to the trading system are received at the trading system interface. The trading system interface routes the order to an appropriate device.

A match engine module 106 may match bid and offer prices for orders configured in accordance with aspects of the invention. Match engine module 106 may be implemented with software that executes one or more algorithms for matching bids and offers for bundled financial instruments in accordance with aspects of the invention. The match engine module and trading system interface may be separate and distinct modules or component or may be unitary parts. Match engine module may be configured to match orders submitted to the trading system. The match engine module may match orders according to currently known or later developed trade matching practices and processes. In an embodiment, bids and orders are matched on price, on a FIFO basis. The matching algorithm also may match orders on a pro-rata basis or combination of FIFO and pro rata basis. Other processes and/or matching processes may also be employed.

Furthermore, an order book module 110 may be included to compute or otherwise determine current bid and offer prices. The order book module 110 may be configured to calculate the price of a financial instrument. Moreover, a trade database 108 may be included to store historical information identifying trades and descriptions of trades. In particular, a trade database may store information identifying or associated with the time that an order was executed and the contract price. The trade database 108 may also comprise a storage device configured to store at least part of the orders submitted by electronic devices operated by traders (and/or other users). In addition, an order confirmation module 132 may be configured to provide a confirmation message when the match engine module 106 finds a match for an order and the order is subsequently executed. The confirmation message may, in some embodiments, be an e-mail message to a trader, an electronic notification in one of various formats, or any other form of generating a notification of an order execution.

A market data module 112 may be included to collect market data and prepare the data for transmission to users. In addition, a settlement pricing module 134 may be included in computer system 100 to receive pricing data and other information and to calculate the settlement price of credit derivative products. An order processing module 136 may be included to receive data associated with an order for a financial instrument. The module 136 may decompose delta based and bulk order types for processing by order book module 110 and match engine module 106. The order processing module 136 may be configured to process the data associated with the orders for financial instruments.

A user database 102 may include information identifying traders and other users of exchange computer system 100. Such information may include user names and passwords. A trader operating an electronic device (e.g., computer devices 114, 116, 118, 120 and 122) interacting with the exchange 100 may be authenticated against user names and passwords stored in the user database 112. Furthermore, an account data module 104 may process account information that may be used during trades. The account information may be specific to the particular trader (or user) of an electronic device interacting with the exchange 100.

The trading network environment shown in FIG. 1 includes computer (i.e., electronic) devices 114, 116, 118, 120 and 122. The computer devices 114, 116, 118, 120 and 122 may include one or more processors, or controllers, that control the overall operation of the computer. The computer devices 114, 116, 118, 120 and 122 may include one or more system buses that connect the processor to one or more components, such as a network card or modem. The computer devices 114, 116, 118, 120 and 122 may also include interface units and drives for reading and writing data or files. Depending on the type of computer device, a user can interact with the computer with a keyboard, pointing device, microphone, pen device or other input device. For example the electronic device may be a personal computer, laptop or handheld computer, tablet pc and like computing devices having a user interface. The electronic device may be a dedicated function device such as personal communications device, a portable or desktop telephone, a personal digital assistant (“PDA”), remote control device, personal digital media system and similar electronic devices.

Computer device 114 is shown communicatively connected to exchange computer system 100. Computer device 114 may be operated by a member/dealer of the exchange to provide requested information (e.g., pricing data). Exchange computer system 100 and computer device 114 may be connected via a T1 line, a common local area network (LAN) a wireless communication device or any other mechanism for communicatively connecting computer devices. Computer (i.e., electronic) devices 116 and 118 are coupled to a local area network (“LAN”) 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a wireless PDA 122 includes mobile telephones and other devices that communicate with a network via radio waves. FIG. 1 also shows LAN 124 connected to the Internet 126. LAN 124 may include a router to connect LAN 124 to the Internet 126. Computer device 120 is shown connected directly to the Internet 126, however, the connection may be via a modem, DSL line, satellite dish or any other device for communicatively connecting a computer device to the Internet.

The operations of computer devices and systems shown in FIG. 1 may be controlled by computer-executable instructions stored on computer-readable storage medium. Embodiments also may take the form of electronic hardware, computer software, firmware, including object and/or source code, and/or combinations thereof. Embodiment may be stored on computer-readable media installed on, deployed by, resident on, invoked by and/or used by one or more data processors (e.g., risk processor), controllers, computers, clients, servers, gateways, networks of computers, and/or any combinations thereof. The computers, servers, gateways, may have one or more controllers configured to execute instructions embodied as computer software. For example, computer device 114 may include computer-executable instructions for receiving settlement price information and other information from computer system 100 and displaying to a user. In another example, computer device 118 may include computer-executable instructions for receiving market data from computer system 100 and displaying that information to a user. In yet another example, a processor 140 (e.g., settlement pricing processor) of computer system 100 may be configured to execute computer-executable instructions that cause the system 100 to calculate settlement prices of credit derivative products.

Of course, numerous additional servers, computers, handheld devices, personal digital assistants, telephones and other devices may also be connected to computer system 100. Moreover, one skilled in the art will appreciate that the topology shown in FIG. 1 is merely an example and that the components shown in FIG. 1 may be connected by numerous alternative topologies.

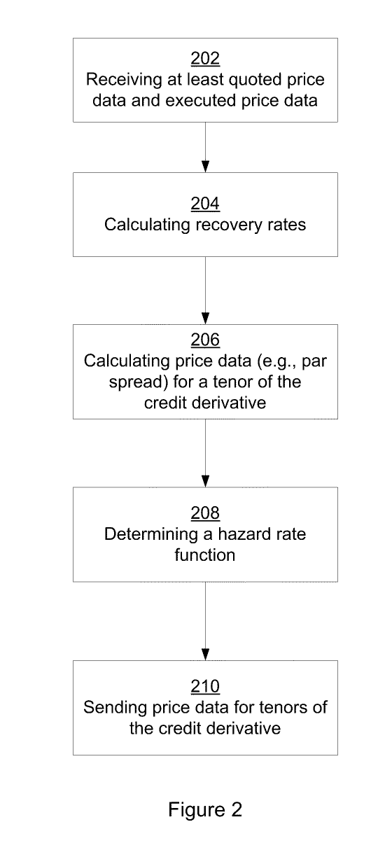

FIG. 2 illustrates an exemplary process and methodology for determining the value of positions for CDS contracts held in a clearinghouse (e.g., CME Group Clearing House). Generally, the method involves collecting and validating data, determining price level and term structure, and calculating position value. In one exemplary embodiment in accordance with the disclosure, all or part of the process may be performed at an exchange computer system 100 comprising one or more modules.

In step 202, a settlement pricing module 134 may receive data corresponding to prices of credit derivatives (e.g., CDS, etc.) The received data may include various types of data. For example, the received data may include executed price data. The executed price data may be sent from a market data module 112 in an electronic exchange system 100. The executed price data may be captured from all trades cleared with the clearinghouse associated with the exchange system 100 on a particular day. Some examples of executed price data obtained from the clearinghouse includes price, time of trade, size of trade, and trade side aggressor.

In another example, the received data may include quoted price data. The quoted price data may be obtained from one or more sources. Some members of the exchange associated with the clearinghouse may be designated as “Founding Members” (or comparable moniker). These Founding Members may be required to submit price data for the full term structures for all indices and reference entities (by seniority, restructuring type, and/or currency) eligible for clearing. Founding Members may submit quoted price data to the exchange system 100 on a regular basis (e.g., twice daily.) Meanwhile, another group of people associated with the exchange system 100 may be designated as “Dealers.” The Dealers and Founding Members may be required to participate in an interactive price auction protocol when dealing with small selected groups of highly illiquid derivatives. The resulting auction quotes may include price and time of the Auction. In some embodiments, the price data obtained from such an auction may override (i.e., replace) individual submissions of Founding Members. The Dealers may also submit quoted price data which has been aggregated by credit market analytics (CMA). These Dealer quotes include bid-offer price, time, and data liquidity depth indicators.

In yet another example, the received data may include position marks. Third-party providers, such as Markit or Fitch, may provide aggregated position marks from books and records of dealers of the exchange. The third-party providers may distribute the received data on a T+1 basis. Alternatively, they may provide the received data in other ways familiar to one of skill in the art. The position marks may include, but are not limited to, price levels, recovery rates, and liquidity depth indicators such as the number of contributors for each aggregated mark.

The price data (e.g., CDS prices) received in step 202 may be in one of many different forms. For example, CDS prices may take the form of upfront prices with running spread, percentage of par, par spread, quote spread, etc. The upfront price may be defined as a percentage of the notional value of the trade that the protection buyer pays the protection seller, in addition to the running standard coupon (e.g., a 5-year protection on XYZ Corp. is 7.6% upfront at 500 bps). The percentage of par may be defined as 1 minus the upfront price with a running standard coupon (e.g., 5-year protection on XYZ Corp. is 92.4% of par at 500 bps). The par spread may be defined as the spread in basis points whereby there is no upfront payment from the protection buyer to the protection seller or vice versa, excluding accruals (e.g., 5-year protection on XYZ Corp. is 710 bps). Par spreads typically need an associated recovery rate to determine the change in value of the CDS position from day to day. The quote spread may be defined as the spread in basis points derived from an upfront price using the widely familiar ISDA CDS standard model using the market standard recovery rate (e.g., 40% recovery rate for senior and 25% for subordinate debt) and flat term structure (e.g., standardized quote of 120 bps against a 100 bps coupon). One skilled in the art will appreciate that price data may take other forms known to those in the financial and derivatives trading art.

In some alternate embodiments, the methodology of FIG. 2 may include a validation step to test the price data against historical and/or current data before it is used to assist in determining the value of positions for CDS contracts. Moreover, analytic credence may be verified through checks on suspicious or negative hazard rate shapes. In accordance with one aspect of the embodiment, executed price data may be validated based on the notional value of the trade. For example, the validation process may conclude that a contract where the 5-year tenor has a par spread greater than 400 bps is a high-yield product.

As a result of the validation, the price data may also be assigned a confidence level that indicates whether the data is reliable. For example, data that does not meet a minimum confidence level threshold may be discarded. The settlement pricing module 134 may filter the price data and discard anything that fails to meet the minimum requirements.

Moreover, the validation process may include converting price data from a first format to a second format (e.g., to harmonize format of the price data). For example, price data received for a reference entity or index that is an upfront price format may be converted into a par spread format using the following formula:

$${U}_{T} + {RS}_{T} \times FeePV {01}_{T} = ParS \times FeePV {01}_{T}$$

$$Then , \\ {ParS}_{T} = {RS}_{T} + \frac{{U}_{T}}{FeePV {01}_{T}}$$

Similarly, price data in a par spread format may be converted to upfront price format using the following formula:

U_{T}=(ParS_{T}−RS_{T})×FeePV01_{T}

In step 204, the settlement pricing module 134 may calculate the recovery rates of the credit derivatives using at least the received data. The recovery rates may be determined using one or more sources of information. One possible source of information is from Founding Members that submit, to the exchange computer system 100, recovery rates for each reference entity and index eligible for clearing and in which the Founding Members have a position. The Founding Members may be penalized for failing to submit recovery rates or for inaccurate recovery rate submissions. Another possible source of information is a financial information services company, such as Markit™ and/or Fitch, for position marks. Yet another possible source of information is credit market analytics (CMA). CMA relies on market data and analytic intelligence as a primary source of recovery rate; CMA then augments these data points with model inputs like bond prices, the shape of the hazard rate curve, and section relationships. Nevertheless, the clearinghouse may determine that relevant market news events (e.g., announcement of a debt auction) or corporate actions (e.g., earnings announcements, etc.) are suggestive of an adjustment in the recovery rates and the clearinghouse may tweak the recovery rate accordingly.

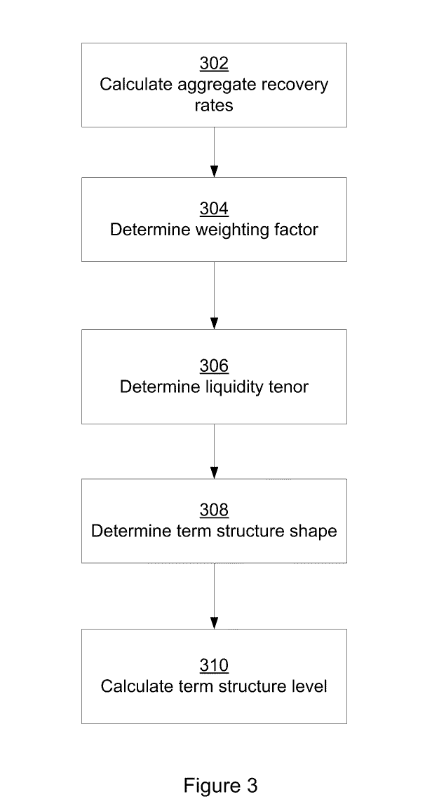

In step 206, the settlement pricing module 134 may calculate the price data for a tenor of the credit derivatives using at least the received data. In one example, the price data that is in varying formats (e.g., upfront price format, par spread format, etc.) may be converted to a uniform par spread format using at least the formulas and techniques discussed herein. The settlement pricing module 134 may use the received data (from step 202), the recovery rates calculated in step 204, and an appropriate interest rate curve to determine the price data for all tenors for each index and reference entity. This may be accomplished through execution of at least one or more of the following steps of FIG. 3.

For example, in step 302, the settlement pricing module 134 may calculate aggregate recovery rates. Recovery rates may be aggregated by taking the trimmed average across all data sources (e.g., Founding Members, position marks, and credit market analytics (CMA)). In one example, the aggregated recovery rate may be used for all pricing conversions, except if par spreads are submitted by Founding Members, then that Founding Member's specified recovery rate is used to calculate the upfront price; these may then be considered alongside other data for aggregation purposes. In another example, the aggregated recovery rate may be used for all pricing conversions, except if quoted spreads are submitted by Founding Members, then a known recovery rate (e.g., market standard 40%/25% recovery rate) with a flat hazard rate assumption may be used to calculate the upfront price; these may be considered alongside other data for aggregation purposes. The aggregate recovery rate may also be used in deriving hazard rates from the converted par spreads during aggregation and position valuation process.

For example, in step 304, a weighting factor may be determined and applied to each source of price data in settlement pricing module 134. Aggregation weightings may be used to determine the most liquid tenor (as discussed below with reference to step 306), the aggregated hazard rate (e.g., derived from par spreads and/or the aggregated recovery rate discussed above in step 302), and/or the aggregated par spread for the most liquid tenor. Aggregation may be based on various weighting factors, including but not limited to, data source type, timing of data, and/or data liquidity. The various weighting factors may be adjusted based on input from market participants and/or the discretion of the clearinghouse.

Regarding the aggregation weighting factor of data source type, executed price data, quoted price data, and position marks may, in one example, each receive a weighting of 100%, 25%, 10% respectively. Executed price data may receive the greatest weight as it represents an actual transaction with committed capital from two parties. Quoted price data may receive a lesser weight than executed price data as they are not firm liquidity commitments. In some example, an exchange may penalize, on a look back basis, Founding Members that are not submitting valid quoted price data. Position marks may receive the lowest weighting as there is little granularity into the precise time relevance. One skilled in the art will appreciate that one or more of these weighting factors may be adjusted to be a greater or lesser percentage of the total aggregate. For example, as the granularity of position marks increases, its weighting may improve accordingly. Moreover, individual weighting factors may be aggregated in a manner (e.g., multiplicative) to yield a single weighting for each source contribution.

Regarding the aggregation weighting factor of timing of data, price levels received closer to the time of mark to market (MTM) may be weighted more heavily than those received further away from the time of MTM. Time weightings decay at an exponential rate, described by the following function:

Wₜᵢₘₑ=e^{(t(pricecontribution)-t(marketclose)×C)}

Where Wₜᵢₘₑ=the time weighting ascribed to the price; t_{price contribution}=the time the price contribution reflected the market; t_{market close}=the time when the settlement price is determined (i.e., time of MTM); and c=constant to reflect the rate of decay of price relevance.

Regarding the aggregation weighting factor of liquidity adjustment, liquidity may be measured different based on the data source type (e.g., executed price data, quoted price data, position marks). For executed price data, the liquidity adjustment may apply discounts for trades less than the average trade size and premiums for trades more than the average trade size for a particular product category (e.g., investment-grade, high-yield, investment grade single, high-yield single, etc.) Furthermore, for a particular product category, an average-sized trade may receive a weighting of 100%. The liquidity weighting for executed prices is given by the following formula:

W_{liquidity}=d₁+e^{(1-N(average trade)/N(executed trade size))*d2}
Where,
W_{liquidity}=liquidity weight applied to Executed Prices
N_{executed trade size}=notional value of executed trade size
N_{average trade size}=notional value of average trade size for each Product Category
d₁, d₂=calibration constants for balancing impact on the ultimate price level, e.g. d₁=25%, d₂=1, subject to transparent change.

Weighting factors may be continually evaluated and refined based on testing of data sources against each other and other prices observed in the market.

For Dealer quotes, the liquidity adjustment may be based on aggregation window since there is a measure of the frequency of observed quotes for a given credit derivative (e.g., the less frequent the quotes, the longer the window required to meet the Dealer quote aggregation criteria). The length of the client-side aggregation window is used to generate the liquidity adjustment such that:

W_{liquidity}=e^{(-length of aggregation window*c)}
Where,
W_{liquidity}=liquidity weight applied to Dealer Quotes
length of aggregation window=notional value of executed trade size
c=constant to reflect the rate of decay of price relevance

The liquidity adjustment for Dealer quotes is by definition less than or equal to 100%, so it can only decrease its own overall weight.

For position marks, in one example, only a single aggregated price level may be reported. As such, the liquidity adjustment may account for the number of contributors for each aggregated price level. The more the contributors, the higher the weighting, as in the example described below:

W_{liquidity}=N_{contributors}*C
Where,
N_{contributors}=factor to describe the number of contributors in the aggregated Price Level
c=constant to reflect the proportional change in weighting per contributor

For example, in step 306, the settlement pricing module 134 may determine the tenor of the credit derivatives that has the most liquidity. In one embodiment, the tenor with the largest tenor weighting factor may be considered the most liquid tenor. The tenor weighting factor may be calculated as the sum of all pricing sources of step 304 for each tenor. Once the liquid tenor is determined, the weighted average pricing data is calculated from each source for that liquid tenor to arrive at the weighted average price for the liquid tenor.

For example, in step 308, the settlement pricing module 134 may determine the term structure shape (i.e., hazard rates for each pricing data source). Par spreads, the aggregate recovery rate, and/or appropriate interest rates may be used to calculate the hazard rates for a tenor for each data source using a bootstrapping technique. Bootstrapping is based on the premise that the expected present value of premium payments equals the expected present value of default payments. Such a bootstrapping technique assumes piecewise constant hazard rates between the tenors (e.g., for non-distressed CDSs, the hazard rate for the 2-year tenor is the same as that of the 3-year tenor.) Given the fragmentation of term structure by the tenors, this assumption allows sufficiently realistic grasp of evolution of the risk-adjusted default probability for underlying credits. A more detailed description of the bootstrapping process is described further below.

Once hazard rates are determined, the hazard rate term structure is captured for each source in terms of the relationship of hazard rates between the non-liquid tenors and the most liquid tenor (identified in step 306). For example, if the 5-year tenor is the most liquid tenor, then the hazard rate ratio for the 1-year tenor can be described as hazard rate of the 1-year tenor divided by the hazard rate of the 5-year tenor. The resulting hazard rate ratios may then be aggregated for each tenor across all applicable sources by applying the next weighting factors. This yields a single proportional relationship of hazard rates for all tenors for each credit derivative. This relationship describes the shape of the term structure for each reference entity and/or index by restructuring type, seniority, and currency.

For example, in step 310, the settlement pricing module 134 may calculate the term structure level. The most liquid tenor (determined in step 306) and the aggregate hazard rate ratios from step 308 may be used to establish the level and shape of the term structure for all tenors associated with the reference entity and/or index of interest. More specifically, a term structure of hazard rates is produced which satisfies both: (1) hazard rate ratios for tenors relative to the most liquid tenor are equal to the aggregated hazard rate ratios, and/or (2) absolute values of these hazard rates are adjusted (e.g., increased, decreased, decreased proportionally by the same factor for all tenors, etc.) so that the price level for the most liquid tenor implied by them is equal to the aggregate price level for the liquid tenor. The resulting settlement hazard rate curve may be converted to par spreads format to yield the term structure level and shape for each index and/or reference entity.

Once the term structure level and shape have been established, price levels for all other cleared maturities can be calculated. Using the settlement hazard rate curve, cumulative default probabilities and corresponding discount factors & cash flows are produced for all maturity dates for both the fixed and contingency legs. For each individual CDS, a par spread is then determined through the assumption that the present value of the fixed and contingency legs are equal. This methodology assumes piecewise constant hazard rates between the tenors (e.g, the hazard rate for the 2-year tenor is the same as that of the 3-year tenor.) The difference between the resulting par spread and the CDS contract coupon is then converted to the percentage of par price to obtain the price for the given contract. In one example, assume par spreads are desired be calculated for a 3.5-year tenor. The term structure may be obtained by performing bootstrapping of the hazard rate function. Once these hazard rates are known, the CDS arbitrage pricing model may be used to imply the par spreads that solve the arbitrage decision for cash flows relevant to a CDS contract with a maturity T=3.5 years:

ParS_{T}×FeePV01_{T}=(1−R)×ContingentPV01_{T}

One skilled in the art, after review of the entirety disclosed herein, will appreciate that an automated or manual check may be performed on the term structure before it is published. The update may include test for the overall curve shape and level, negative forwards, differences in senior and subordinated spreads, significant “overnight” idiosyncratic shifts, deviations from secondary data sources, etc. Any term structure that fails may be appropriately manually adjusted by analysts specializing in that sector or index. After passing all checks, the resulting par spread and percentage of par data may be published, in some embodiments, as the settlement prices for each CDS.

Referring back to FIG. 2, in step 208, the settlement pricing module 134 may determine a hazard rate function that can be used to calculate price data for a plurality of tenors of the credit derivatives. The following exemplary table shows the price data (in par spread format) from various sources:

| | Par Spreads (bps) by Required Tenor | | | | |
|---|---|---|---|---|---|
| Data Source | 1 | 3 | 5 | 7 | 10 |
| Position Marks | 140 | 140 | 140 | 140 | 140 |
| Traded Price A | | | 160 | | |
| Traded Price B | | | 176 | | |
| Dealer Quotes A | | | 165 | | |
| Dealer Quotes B | 165 | 170 | 175 | | |
| Founding Member A | 150 | 150 | 160 | 170 | 170 |
| Founding Member B | 160 | 160 | 175 | 180 | 180 |
| Founding Member C | 165 | 170 | 175 | 180 | 185 |

Hazard rates may be calculated from the par spread values associated with each price data source by using bootstrapping techniques.

Bootstrapping, in one example, may be used to assist in determining survival probabilities as a function of the previous survival probability and a conditional survival probability for a new time period. Assuming a critical value to determining the survival probabilities is the time of default, then default probability up to a time “t” may be defined as:

PD(t)=Prob(γ≦t)

Hence the survival probability up to a time t is simply:

PS(t)=1−PD(t)=Prob(γ>t)

Furthermore, assuming a continuous time function of the survival probability, then the survival probability to the hazard rate is defined as:

PS(t)=exp(−∫₀^{t}λ(t)dt)

In order to solve the preceding formula, a series of break points in time may be used with the assumption that that hazard rate function is constant over intervals given by those break points. Hence the hazard rate function may have any piecewise constant shape over the term structure. Moreover, additional break points may be added to allow more accurate reflection of inversion spikes for distressed instruments. For example, a CDS term structure for a 10-year CDS may be constructed with a piecewise constant hazard rate function as follows:

τ=d₁−d₀t _{ω̅}years

If 0<τ≦1=>λ_{0,1}=>PS_{0,1}

If 1<τ≦3=>λ_{1,3}=>PS_{1,3}

If 3<τ≦5=>λ_{3,5}=>PS_{3,5}

If 5<τ≦7=>λ_{5,7}=>PS_{5,7}

If 7<τ≦10=>λ_{7,10}=>PS_{7,10}

The same structure can be applied assuming quarterly payments as:

If 0<t≦1+1×4=>λ_{0,1}=>PS_{0,1}

If 1+1×4<t≦1+3×4=>λ_{1,3}=>PS_{1,3}

If 1+3×4<t≦1+5×4=>λ_{3,5}=>PS_{3,5}

If 1+5×4<t≦1+7×4=>λ_{5,7}=>PS_{5,7}

If 1+7×4<t≦1+10×4=>λ_{7,10}=>PS_{7,10}

The preceding formula may be further simplified into a hazard rate function with respect to time. In doing so, the conditional survival probability is a function of the hazard rate. With uniform price data and calculated recovery rates ready for the entire term structure, an application of a CDS arbitrage pricing model solves for the hazard rates. CDS pricing arbitrage theory is based on the notion that for par spreads, the net present value of the coupon payment leg (i.e., the fee leg) equals the present value of the contingent payment leg (i.e., the contingent leg).

In order to determine the values of the hazard rate function, the bootstrapping process solves the arbitrage equation for the 1-year spread as described by the following formula:

$${U}_{T} + {RS}_{T} {\sum }_{t = 1}^{I} {b}_{0 , t} \times {PS}_{0 , t} \times ( {t}_{t} - {t}_{t - 1} ) + {RS}_{T} {\sum }_{t = 1}^{I} {b}_{0 , t} \times ( {PS}_{0 , t - 1} - {PS}_{0 , t} ) \times \frac{{t}_{t} - {t}_{t - 1}}{2} = ( 1 - R ) {\sum }_{t = 1}^{I} {b}_{0 , t} \times ( {PS}_{0 , t - 1} - {PS}_{0 , t} )$$

Where, for a 1-year contract, I=1+1*4=5 coupon payments.

Assuming the hazard rate function remains constant over all dates up to a 1-year contract maturity date, the formula for such calculations may be calculated. The bootstrapping process may be repeated in sequence, solving for the 3-, 5-, 7-, 10-year hazard rates, etc. Thus, a hazard rate term structure may be built by calibrating the hazard rate function from the observed quotes.

In step 210, the settlement pricing module 134 may transmit the price data for the plurality of tenors of the credit derivatives. The transmitting (in step 210) may be carried out in numerous ways, including but not limited to, using electronic communication, such as e-mail, SMS, instant message, etc.) The recipients of the transmission may be modules in an exchange computer system 100. In addition, the price data generated by the settlement pricing module 134 may be used to determine the settlement prices for all maturity dates for the reference entity or index. The determination may use the aggregate hazard rate curve, cumulative default probabilities and corresponding discount factors.

Once settlement prices are determined, the mark-to-market (MTM) value of each position may be determined as follows:

MtM=(100−Percent of Par)*Notional Value, or

MtM=(Par Spread−Running Coupon)*PV01_{Fixed Leg}*Notional Value
Where,
MtM=current value of the position (i.e., mark-to-market value)
Percentage of Par=1−Upfront Price with a Running Coupon
Running Coupon=fixed coupon payment from protection buyer to seller
PV01_{Fixed Leg}=present value of a 1-basis point change in par spread

In addition, the position value (or mark-to-market value) relies on re-pricing of the CDS contract in terms of the fixed coupon per contract. This can be done by using the bootstrapping methodology of the hazard rate function, then use the CDS arbitrage pricing model to calculate the market value of the fee leg using the fixed coupon; and finally, since the hazard rate term structure was calibrated, the formula may be simplified to:

$$\begin{matrix}{U}_{T} + {RS}_{T} \times FeePV {01}_{T} = {ParS}_{T} \times FeePV {01}_{T} \\ = ( 1 - R ) \times ContingentPV {01}_{T}\end{matrix}$$

Thus the equation can be simplified to:

MtM=N*(C−RS_{T})*FeePV01_{T}

One skilled in the art will recognize the various abbreviations/acronyms and notation that has been used through the disclosure. Nevertheless, the following is a list of at least some of the notation used throughout: “PS” for survival probability; “PSxy” for conditional survival probability starting at time x and ending at time y, “b” for discount factor; “t” for day in years; “RS” for running spread; “ParS” for par spread; “C” for coupon; “R” for recovery rate; “A” for hazard rate; “U” for upfront; and “N” for notional.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. For example, although numerous examples recite CDS, one skilled in the art will appreciate that the novel principles disclosed herein may be applied to other types of financial instruments and still fall within the scope of the invention contemplated herein.

We claim:

1. A method, comprising:
receiving, at a settlement pricing module, data corresponding to prices of credit derivatives, wherein the received data comprises quoted price data and executed price data, wherein the executed price data is sent from at least a market data module in an electronic exchange system;
calculating recovery rates of the credit derivatives using at least the received data;
calculating price data for a tenor of the credit derivatives using at least the received data, where the price data comprises par spread values;
determining, at the settlement pricing module, using at least the calculated recovery rates, a hazard rate function configured for use in calculating price data for a plurality of tenors of the credit derivatives; and
sending, from the settlement pricing module, the price data for the plurality of tenors of the credit derivatives.

2. The method of claim 1, further comprising:
identifying, at the settlement pricing module, a most liquid tenor of the plurality of tenors of the credit derivative using weighting factors.

3. The method of claim 1, where the credit derivatives are all associated with a common index.

4. The method of claim 1, wherein the data corresponding to prices of credit derivatives further comprises quote spread values for the credit derivatives, and the method further comprising:
converting the quote spread values to par spread values for the credit derivatives.

5. The method of claim 1, wherein the data corresponding to prices of credit derivatives further comprises upfront price values for the credit derivatives, and the method further comprising:
converting the upfront price values to par spread values for the credit derivatives.

6. The method of claim 1, wherein the data corresponding to prices of credit derivatives further comprises percentage of par values for the credit derivatives, and the method further comprising:
converting the percentage of par values to par spread values for the credit derivatives.

7. The method of claim 1, wherein the recovery rate for the credit derivatives is calculated using information about market events.

8. The method of claim 1, wherein the calculating of the recovery rates includes adjusting the calculated recovery rate in accordance with the market news events and corporate actions.

9. The method of claim 1, further comprising:
validating, at the settlement pricing module, the received data.

10. The method of claim 9, wherein the validating includes testing the received data against historical financial data.

11. The method of claim 1, further comprising:
discarding at least some of the received data for failure to meet a minimum confidence level threshold.

12. A computer-readable medium containing computer-executable instructions for performing, at a settlement pricing module, a method comprising:
receiving data corresponding to prices of credit derivatives, wherein the received data comprises quoted price data and executed price data, wherein the executed price data is sent from at least a market data module in an electronic exchange system;
calculating recovery rates of the credit derivatives using at least the received data;
calculating price data for a tenor of the credit derivatives using at least the received data, where the price data comprises par spread values;
determining a hazard rate function configured for use in calculating price data for a plurality of tenors of the credit derivatives, wherein the determining a hazard rate function uses at least the calculated recovery rates; and
sending the price data for the plurality of tenors of the credit derivatives.

13. The computer-readable medium of claim 12, the method further comprising:
identifying, at the settlement pricing module, a most liquid tenor of the plurality of tenors of the credit derivative using weighting factors.

14. The computer-readable medium of claim 12, wherein the data corresponding to prices of credit derivatives further comprises quote spread values for the credit derivatives, and the method further comprising:
converting the quote spread values to par spread values for the credit derivatives.

15. The computer-readable medium of claim 12, wherein the recovery rate for the credit derivatives is calculated using information about market events, the calculating of the recovery rates includes adjusting the calculated recovery rate in accordance with the market news events and corporate actions.

16. The computer-readable medium of claim 12, wherein the data corresponding to prices of credit derivatives further comprises quote spread values for the credit derivatives, and the method further comprising:
converting the quote spread values to par spread values for the credit derivatives.

17. The computer-readable medium of claim 12, wherein the data corresponding to prices of credit derivatives further comprises upfront price values for the credit derivatives, and the method further comprising:
converting the upfront price values to par spread values for the credit derivatives.

18. An apparatus comprising:
a computer memory, where the memory stores at least quoted price data and executed price data; and
a processor coupled to the memory, where the processor is configured to execute:
a settlement pricing module that uses at least the quoted price data and the executed price data to determine price data for a plurality of tenors of a credit derivative.

19. The apparatus of claim 18, wherein the processor is further configured for:
calculating recovery rates of the credit derivative using at least the quoted price data and the executed price data; and
calculating price data for a tenor of the credit derivatives using at least the received data, where the price data comprises par spread values.

20. The apparatus of claim 18, wherein the processor is further configured for:
validating the quoted price data and the executed price data, wherein the validating includes testing the received data against historical financial data.
